(19) United States
(12) Patent Application Publication
(10) Pub. No.: US 2011/0117431 A1
(43) Pub. Date: May 19, 2011

(54) LITHIUM SECONDARY BATTERY AND METHOD OF MANUFACTURING THE SAME

(75) Inventors: Atsushi Fukui, Kobe-shi (JP); Taizou Sunano, Kobe-shi (JP); Maruo Kamino, Kobe-shi (JP)

(73) Assignee: SANYO ELECTRIC CO., LTD., Osaka (JP)

(21) Appl. No.: 12/868,305

(22) Filed: Aug. 25, 2010

(30) Foreign Application Priority Data
Aug. 25, 2009 (JP) 2009-194071

(51) Int. Cl. H01M 4/62; H01M 10/00

(52) U.S. Cl. 429/217; 29/623.5

(57) ABSTRACT

A lithium secondary battery including an electrode assembly and a non-aqueous electrolyte impregnated in the electrode assembly, the electrode assembly containing a positive electrode, a negative electrode having a negative electrode current collector and a negative electrode mixture layer formed on the negative electrode current collector, the negative electrode mixture layer containing a binder and negative electrode active material particles, the negative electrode active material particles containing at least one of silicon and a silicon alloy, and a separator interposed between the negative electrode and the positive electrode. The binder contains a polyimide resin having a branch structure formed by imidizing a polyvalent amine having a valency of 3 or more and a tetracarboxylic dianhydride.

### BACKGROUND OF THE INVENTION

1. Field of the Invention

The present invention relates to lithium secondary batteries and method of manufacturing the batteries. More particularly, the invention relates to a lithium secondary battery having a negative electrode employing negative electrode active material particles containing at least one of silicon and a silicon alloy, and a method of manufacturing the battery.

2. Description of Related Art

In recent years, demands for higher energy density lithium secondary batteries have been growing. Accordingly, much research effort is devoted to the study of negative electrode active materials capable of achieving higher energy density than graphite materials, which have been conventionally used as common negative electrode active materials. One example of such a negative electrode active material is an alloy material containing an element such as Al, Sn, and Si and being capable of alloying with lithium.

The alloy material containing an element such as Al, Sn, and Si and being capable of alloying with lithium is a negative electrode active material that occludes lithium by alloying reaction with lithium, and it has a greater capacity per volume than graphite materials. Therefore, use of the alloy material containing an element such as Al, Sn, and Si and being capable of alloying with lithium as a negative electrode active material can achieve a higher energy density lithium secondary battery.

However, the negative electrode employing the alloy material containing an element such as Al, Sn, and Si and being capable of alloying with lithium as the negative electrode active material has the phenomenon that the volume of the negative electrode active material greatly changes greatly during charge and discharge, i.e., at the time of lithium occlusion and release. As a consequence, pulverization of the negative electrode active material and separation of the negative electrode mixture layer from the current collector tend to occur easily. The pulverization of the negative electrode active material and the separation of the negative electrode mixture layer from the current collector lead to degradation in the current collection performance in the negative electrode, resulting in the problem of deterioration of the charge-discharge cycle performance of the lithium secondary battery.

In relation to such problems, Japanese Published Unexamined Patent Application No. 2002-260637 proposes a method of sintering, in a non-oxidizing atmosphere, a layer of a mixture containing a polyimide binder and active material particles containing at least one of silicon and a silicon alloy on a current collector. The publication describes that use of the negative electrode obtained by their described method can yield good cycle performance.

PCT Publication No. WO 04/004031 A1 and Japanese Published Unexamined Patent Application Nos. 2007-242405 and 2008-34352 propose to obtain good cycle performance by optimizing the negative electrode binder contained in the negative electrode mixture layer. PCT Publication No. WO 04/004031 A1 proposes the use of a polyimide having predetermined mechanical characteristics as the negative electrode binder. Japanese Published Unexamined Patent Application No. 2007-242405 proposes the use of an imide compound obtained by decomposing a binder precursor composed of a polyimide or a polyamic acid by a heat treatment as the negative electrode binder. Japanese Published Unexamined Patent Application No. 2008-34352 proposes the use of a polyimide composed of 3,3′,4,4′-benzophenonetetracarboxylic dianhydride and either m-phenylenediamine or 4,4′-diaminodiphenyl methane as the negative electrode binder.

However, there have been demands for further higher charge-discharge cycle performance in lithium secondary batteries.

### BRIEF SUMMARY OF THE INVENTION

The present invention has been accomplished in view of the foregoing circumstances, and it is an object of the invention to provide a lithium secondary battery using at least one of at least one of silicon and a silicon alloy as a negative electrode active material and having excellent charge-discharge cycle performance.

The lithium secondary battery according to the present invention has an electrode assembly and a non-aqueous electrolyte. The electrode assembly comprises a negative electrode, a positive electrode, and a separator. The separator is interposed between the negative electrode and the positive electrode. The non-aqueous electrolyte is impregnated in the electrode assembly. The negative electrode has a negative electrode current collector and a negative electrode mixture layer. The negative electrode mixture layer is formed on the negative electrode current collector. The negative electrode mixture layer contains negative electrode active material particles and a binder. The negative electrode active material particles contain at least one of silicon and a silicon alloy. The binder contains a polyimide resin having a branch structure formed by imidizing a polyvalent amine having a valency of 3 or more and a tetracarboxylic dianhydride.

The present invention uses a polyimide resin having a branch structure as a binder. The polyimide resin having a branch structure has greater mechanical strength than, for example, a polyimide resin that has no branch structure and is composed of only a linear chain structure. For this reason, in the present invention, the polyimide resin serving as the binder does not break easily even when the volume of the active material microparticle changes greatly during charge and discharge. As a result, pulverization of the negative electrode active material microparticles or separation of the negative electrode mixture layer from the negative electrode current collector do not occur easily. Thus, the current collection performance of the negative electrode does not deteriorate easily, and a lithium secondary battery having outstanding charge-discharge cycle performance can be achieved.

A polyimide resin has a rigid imide bond. Therefore, both the polyimide resin composed of only a linear chain structure and the polyimide resin having both a linear chain structure and a branch structure have a highly rigid molecular structure. For this reason, the molecular shape of the polyimide resin varies greatly depending on the shape of the bond.

In the case of the polyimide resin composed of only a linear chain structure, the directions of the bonds are limited to two directions. Therefore, the polymer chains stretch one-dimensionally. As a consequence, the molecular shape of the polyimide resin composed of only a linear chain structure becomes a planar shape. For this reason, the polyimide resin composed of only a linear chain structure covers the negative electrode active material microparticles and the negative electrode current collector in a planar shape. Consequently, the proportion of the areas of the negative electrode active material microparticle surface and the negative electrode current collector surface that are not covered with the insulative polyimide resin is small. As a consequence, it is difficult for the negative electrode active material microparticles to easily make contact directly with each other or with the negative electrode current collector, without the intervention of the insulative polyimide. This results in low electron conductivity in the negative electrode.

In contrast, in the case of the polyimide resin having a branch structure, which is used in the present invention, the bonds exist in three or more directions. As a consequence, the molecular shape of the polyimide resin having a branch structure becomes a particulate shape. For this reason, when the polyimide resin having a branch structure is used as the binder, the proportion of the areas of the negative electrode active material microparticle surface and the negative electrode current collector surface that are covered by the insulative polyimide resin is small. As a result, the negative electrode active material microparticles easily make contact directly with each other and with the negative electrode current collector without the intervention of the insulative polyimide. Therefore, electron conductivity in the negative electrode can be enhanced. As a result, excellent charge-discharge cycle performance can be obtained.

In the present invention, the polyvalent amine having a valency of 3 or more, which is a source material of the polyimide resin having a branch structure, is not particularly limited. For example, any known polyvalent amine having a valency of 3 or more may be used.

It is preferable that the amine having a valency of 3 or more used in the present invention be an amine having a valency of from 3 to 6, more preferably a polyvalent amine having a valency of 3 (triamine) or a polyvalent amine having a valency of 4 (tetraamine), and still more preferably a triamine.

The use of the polyvalent amine having a valency of 3 or more makes the mechanical strength of the polyimide resin even higher. However, if a polyvalent amine having a valency of 5 or more is used, flexibility of the branch structure, i.e., deformability of the branch structure, reduces. This increases the brittleness of the polyimide resin. As a consequence, the polyimide resin serving as the binder becomes susceptible to destruction during charge and discharge. Moreover, the adhesion strength between the negative electrode mixture layer and the negative electrode current collector also decreases.

On the other hand, triamine has higher flexibility of the branch structure than the polyvalent amines having a valency of 4 or more. For this reason, the use of triamine can inhibit the destruction of the polyimide resin during charge and discharge more effectively. Moreover, the adhesion strength between the negative electrode mixture layer and the negative electrode current collector can be increased more effectively. As a result, even higher charge-discharge cycle performance can be obtained.

Examples of the triamine include aromatic triamine, 2,4,6-triamino-1,3,5-triazine (also known as melamine), and 1,3,5-triaminocyclohexane.

Specific examples of the aromatic triamine include tris(4-aminophenyl)methanol (also known as pararosaniline) represented by the following formula (1), tris(4-aminophenyl)methane, 3,4,4′-triaminodiphenyl ether represented by the following formula (2), 3,4,4′-triaminobenzophenone, 3,4,4′-triaminodiphenylmethane, 1,4,5-triaminonaphthalene, tris(4-aminophenyl)amine, 1,2,4-triaminobenzene represented by the following formula (3), and 1,3,5-triaminobenzene.

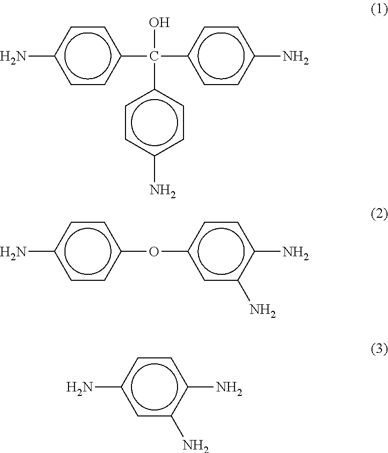

Among these examples, tris(4-aminophenyl)methanol, 3,4,4′-triaminodiphenyl ether, and 1,2,4-triaminobenzene are available on the market at relatively less cost.

From the viewpoint of obtaining a polyimide resin with good binding capability, it is preferable to use, as the polyvalent amine, a triamine such as tris(4-aminophenyl)methanol, tris(4-aminophenyl)methane, tris(4-aminophenyl)amine, 1,3,5-triaminobenzene, 2,4,6-triamino-1,3,5-triazine, and 1,3,5-triaminocyclohexane. In these triamines, the amine groups in the molecule show highly symmetrical arrangement. Accordingly, the three-dimensional symmetry of the resulting polyimide chain having a branch structure obtained by the imidization with a tetracarboxylic dianhydride becomes high. As a result, it is believed that good binding capability can be obtained.

From the viewpoint of obtaining high heat resistance in addition to good binding capability, it is preferable to use an aromatic triamine such as tris(4-aminophenyl)methanol, tris(4-aminophenyl)methane, tris(4-aminophenyl)amine, and 1,3,5-triaminobenzene. The use of such a polyvalent amine having high heat resistance inhibits decomposition of the polyvalent amine when heat-treating for causing an imidization reaction between the polyvalent amine and a tetracarboxylic dianhydride, allowing a desired polyimide resin to form at a high yield rate.

Thus, from all the viewpoints of price, binding capability, and heat resistance, it is especially preferable to use tris(4-aminophenyl)methanol represented by the above formula (1).

Specific examples of the tetraamine include tetrakis(4-aminophenyl)methane, 3,3′,4,4′-tetraminodiphenyl ether, 3,3′,4,4′-tetraminobenzophenone, 3,3′,4,4′-tetraminodiphenyl methane, and N,N,N′N′-tetrakis(4-methylphenyl)benzidine.

In the present invention, the tetracarboxylic dianhydride is not particularly limited either. For example, any known tetracarboxylic dianhydride may be used.

It is preferable that the tetracarboxylic dianhydride be, for example, an aromatic tetracarboxylic dianhydride. Specific examples of the aromatic tetracarboxylic dianhydride include 1,2,4,5-benzenetetracarboxylic 1,2:4,5-dianhydride (also known as pyromellitic dianhydride), 3,3′,4,4′-benzophenonetetracarboxylic dianhydride represented by the following chemical formula (4), 3,3′,4,4′-biphenyltetracarboxylic dianhydride, 3,3′,4,4′-diphenylsulfonetetracarboxylic dianhydride, 3,3′,4,4′-diphenylethertetracarboxylic dianhydride, and 3,3′,4,4′-diphenylmethanetetracarboxylic dianhydride.

Among these, 3,3′,4,4′-benzophenonetetracarboxylic dianhydride represented by the following chemical formula (4) and 3,3′,4,4′-biphenyltetracarboxylic dianhydride are preferable from the viewpoint of obtaining a polyimide resin with high mechanical strength and high flexibility, and 3,3′,4,4′-benzophenonetetracarboxylic dianhydride is particularly preferable. In these tetracarboxylic dianhydrides, two aromatic rings are positioned on the same plane at all times. Therefore, by using these tetracarboxylic dianhydrides, a polyimide resin that provides a desirable balance between mechanical strength and flexibility can be obtained.

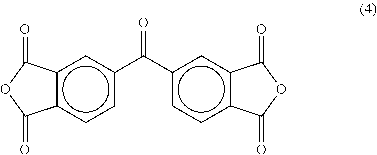

In the present invention, the branch structure of the polyimide is formed by imidizing the foregoing polyvalent amine and the foregoing tetracarboxylic dianhydride.

For example, when tris(4-aminophenyl)methanol represented by the above formula (1) is used as the polyvalent amine and 3,3′,4,4′-benzophenonetetracarboxylic dianhydride represented by the above formula (4) is used as the tetracarboxylic dianhydride, the branch structure represented by the following formula (5) is formed.

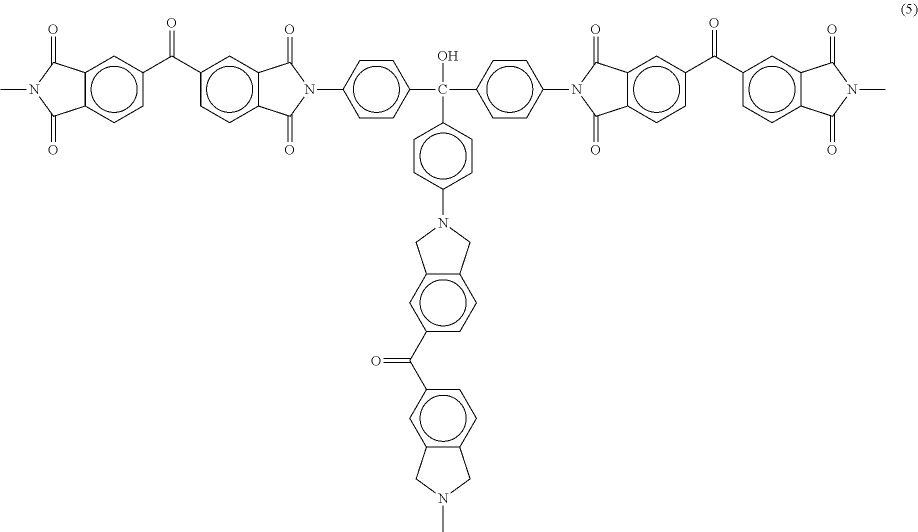

Alternatively, when, for example, 3,4,4′-triaminodiphenyl ether represented by the above formula (2) is used as the polyvalent amine and 3,3′,4,4′-benzophenonetetracarboxylic dianhydride represented by the above formula (4) is used as the tetracarboxylic dianhydride, the branch structure represented by the following formula (6) is formed.

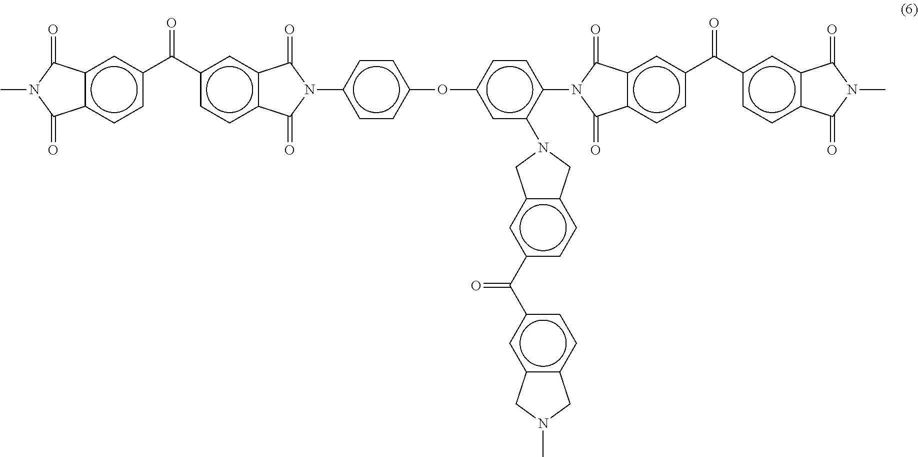

Alternatively, when, for example, 1,2,4-triaminobenzene represented by the above formula (3) is used as the polyvalent amine and 3,3′,4,4′-benzophenonetetracarboxylic dianhydride represented by the above formula (4) is used as the tetracarboxylic dianhydride, the branch structure represented by the following formula (7) is formed.

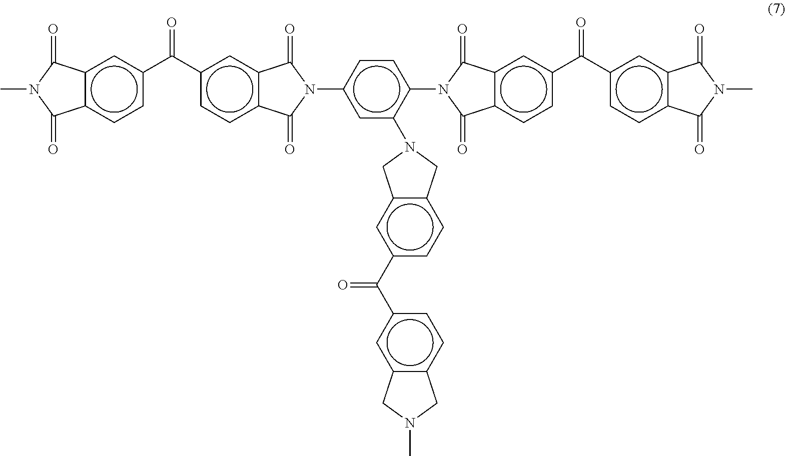

In the present invention, it is preferable that the polyimide resin further have a linear chain structure formed by imidizing a diamine and a tetracarboxylic dianhydride, in addition to the branch structure. The linear chain structure formed by imidizing a diamine and a tetracarboxylic dianhydride has higher flexibility than the branch structure formed by imidizing a polyvalent amine having a valency of 3 or more and a tetracarboxylic dianhydride. For this reason, the use of the polyimide resin containing the linear chain structure as well as the branch structure enhances the adhesion between the negative electrode current collector and the negative electrode mixture layer. Thus, by containing the linear chain structure in the polyimide resin in addition to the branch structure, both mechanical strength and flexibility of the polyimide resin can be increased, and the adhesion between the negative electrode current collector and the negative electrode mixture layer can be enhanced.

The linear chain structure formed by imidizing a diamine and a tetracarboxylic dianhydride may be formed by causing an imidization reaction after adding the diamine to the polyvalent amine and the tetracarboxylic dianhydride.

In the present invention, the diamine is not particularly limited. In the present invention, the diamine may preferably be an aromatic diamine, for example. Specific examples of the aromatic diamine include m-phenylenediamine represented by the following formula (8), p-phenylenediamine, 3,3′-diaminobenzophenone, 4,4′-diaminobiphenyl, 4,4′-diaminodiphenylsulfone, 4,4′-diaminophenylether, 4,4′-diaminophenylmethane, 2,2-bis[4-(4-aminophenoxy)phenyl]propane, 1,4-bis(3-aminophenoxy)benzene, and 1,4-bis(4-aminophenoxy)benzene.

Among these, it is more preferable to m-phenylenediamine represented by the following formula (8), taking into consideration the balance between mechanical strength and flexibility of the resulting polyimide resin. m-Phenylenediamine contains one aromatic ring, and it has an amino group in the meta position of the aromatic ring. For this reason, m-phenylenediamine has high mechanical strength resulting from the structure of the aromatic ring and high flexibility resulting from the amino group being in the meta position. Therefore, the use of m-phenylenediamine makes it possible to obtain a polyimide resin that provides a desirable balance between mechanical strength and flexibility.

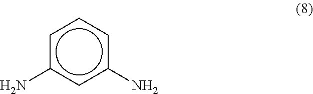

In the present invention, the linear chain structure is formed by imidizing the foregoing diamine and the foregoing tetracarboxylic dianhydride.

For example, when m-phenylenediamine represented by the above formula (8) is used as the diamine and 3,3′,4,4′-benzophenonetetracarboxylic dianhydride represented by the above formula (4) as the tetracarboxylic dianhydride, the linear chain structure represented by the following formula (9) is formed.

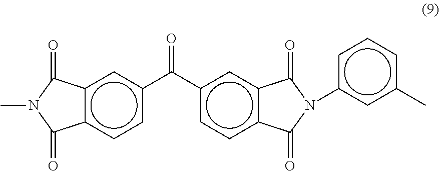

In the present invention, it is preferable that the mole ratio of the branch structure derived from a polyvalent amine having a valency of 3 or more and the linear chain structure derived from a diamine [(the branch structure derived from a polyvalent amine having a valency of 3 or more):(the linear chain structure derived from a diamine)] be within the range of from 10:90 to 30:70. With this configuration, a desirable balance between the mechanical strength resulting from the presence of the branch structure and the flexibility resulting from the presence of the linear chain structure is achieved, and a polyimide resin that has both good mechanical strength and good adhesion can be obtained.

On the other hand, if the mole ratio of the branch structure derived from a polyvalent amine having a valency of 3 or more and the linear chain structure derived from a diamine [(the branch structure derived from a polyvalent amine having a valency of 3 or more):(the linear chain structure derived from a diamine)] is less than 10/90, it may be difficult to obtain a polyimide resin with sufficient mechanical strength, because the proportion of the branch structure is too low. Consequently, destruction of the polyimide resin may easily occur during charge and discharge, resulting in poor charge-discharge cycle performance.

Also, if the mole ratio of the branch structure derived from a polyvalent amine having a valency of 3 or more and the linear chain structure derived from a diamine [(the branch structure derived from a polyvalent amine having a valency of 3 or more):(the linear chain structure derived from a diamine)] exceeds 30/70, the flexibility of the polyimide may be too low because the proportion of the branch structure is too high. Consequently, the adhesion between the negative electrode mixture layer and the negative electrode current collector may degrade, resulting in poor charge-discharge cycle performance.

In the present invention, the negative electrode current collector is not particularly limited as long as it has electrical conductivity. For example, the negative electrode current collector may be composed of a conductive metal foil. Specific examples of the conductive metal foil include a foil of a metal such as copper, nickel, iron, titanium, cobalt, manganese, tin, and silicon, and an alloy foil formed of a combination thereof. Since it is preferable that the conductive metal foil contain a metal element that is easily diffused in the active material particles, it is preferable that the negative electrode current collector be formed of a copper thin film or a foil made of an alloy containing copper.

The thickness of the negative electrode current collector is not particularly limited. It may be from about 10 μm to about 100 μm.

The type of the negative electrode active material particles containing at least one of silicon and a silicon alloy, which are contained in the negative electrode mixture layer together with the binder, is not particularly limited. The silicon alloy is not particularly limited as long as it functions as a negative electrode active material.

Specific examples of the silicon alloy include a solid solution of silicon and at least one other element, an intermetallic compound of silicon and at least one other element, and a eutectic alloy of silicon and at least one other element. Examples of the method for producing the alloy containing silicon include arc melting, liquid quenching, mechanical alloying, sputtering, chemical vapor deposition, and baking. Specific examples of the liquid quenching include a single-roll quenching technique, a double-roller quenching technique, and various atomization techniques such as gas atomization, water atomization, and disk atomization.

The negative electrode active material particles may be particles of silicon and/or a silicon alloy in which the particle surface is coated with a metal or an alloy. Examples of the method of the coating include electroless plating, electroplating, chemical reduction, evaporation, sputtering, and chemical vapor deposition. It is preferable that the metal that is coated on the surfaces of the particles be the same kind of metal as that used for the conductive metal foil that forms the negative electrode current collector or the later-described conductive metal powder. By coating the particles with the same kind of metal as used for the conductive metal foil or the conductive metal powder, the bonding between the current collector and the conductive metal powder at the time of sintering is improved greatly, and even higher charge-discharge cycle performance can be obtained.

Although the average particle size of the negative electrode active material particles is not particularly limited, it is preferable that, for example, it be 100 μm or less, and more preferably 50 μm or less.

In the present invention, the negative electrode mixture layer may further contain conductive powder, such as conductive metal powder and conductive carbon powder. A preferable example of the conductive metal powder is conductive powder made of the material used for the foregoing conductive metal foil. Preferable examples of the conductive metal powder include powders formed of metals such as copper, nickel, iron, titanium, and cobalt, and powders formed of alloys of combinations thereof. Although the average particle size of the conductive powder is not particularly limited, it is preferable that it be 100 μm or less, and more preferably 50 μm or less.

In the present invention, the positive electrode, the separator, and the non-aqueous electrolyte are not particularly limited, and for example, any known positive electrode, separator, and non-aqueous electrolyte may be used.

The positive electrode commonly comprises a positive electrode current collector composed of a conductive metal foil, and a positive electrode mixture layer formed on the positive electrode current collector. The positive electrode mixture layer contains a positive electrode active material. The positive electrode active material is not particularly limited as long as it is capable of electrochemically inserting and deinserting lithium. Specific examples of the positive electrode active material include lithium-containing transition metal oxides, such as LiCoO₂, LiNiO₂, LiMn₂O₄, LiMnO₂, LiCO_{0.5}Ni_{0.5}O₂, and LiNi_{0.7}CO_{0.2}Mn_{0.1}O₂, and metal oxides that do not contain lithium, such as MnO₂.

In addition, the solvent used for the non-aqueous electrolyte is not particularly limited. Specific examples of the solvent used for the non-aqueous electrolyte include: cyclic carbonates such as ethylene carbonate, propylene carbonate, butylene carbonate, and fluoroethylene carbonate; chain carbonates such as dimethyl carbonate, methyl ethyl carbonate, and diethyl carbonate; and mixed solvents of a cyclic carbonate and a chain carbonate.

The solute used for the non-aqueous electrolyte is not particularly limited either. Specific examples of the solute used for the non-aqueous electrolyte include LiPF₆, LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, and mixtures thereof. It is also possible to use, as the electrolyte, a gelled polymer electrolyte in which an electrolyte solution is impregnated in a polymer electrolyte such as polyethylene oxide and polyacrylonitrile, and an inorganic solid electrolyte such as LiI or Li₃N.

In addition, it is preferable that CO₂ be contained in the non-aqueous electrolyte.

The method of manufacturing a lithium secondary battery according to the present invention comprises the steps of: adding a polyvalent amine having a valency of 3 or more to an esterified product of a tetracarboxylic dianhydride with an alcohol formed by reacting the tetracarboxylic dianhydride with a monohydric alcohol to prepare a binder precursor solution; dispersing negative electrode active material particles in the binder precursor solution to prepare a negative electrode mixture slurry; applying the negative electrode mixture slurry onto a negative electrode current collector; heat-treating the negative electrode current collector on which the negative electrode mixture slurry is applied in a non-oxidizing atmosphere so as to cause an imidization reaction and a polymerization reaction of the tetracarboxylic dianhydride and the polyvalent amine having a valency of 3 or more, whereby a polyimide resin having a branch structure is formed, to prepare a negative electrode; interposing a separator between the negative electrode and a positive electrode to prepare an electrode assembly; and impregnating the electrode assembly with a non-aqueous electrolyte to prepare the lithium secondary battery.

The manufacturing method according to the present invention makes it possible to manufacture the foregoing lithium secondary battery according to the present invention. As a result, a lithium secondary battery having excellent charge-discharge cycle performance can be obtained.

The present invention uses, as the binder precursor solution, a mixture of an esterified product of a tetracarboxylic dianhydride with an alcohol and a polyvalent amine having a valency of 3 or more, which are monomer components of the polyimide resin. This mixture of monomer components has a lower viscosity than a binder precursor in polymer form such as a polyamic acid, which is commonly used as a precursor of a polyimide resin. For this reason, the use of the mixture of the monomer components as a binder precursor solution according to the present invention allows the binder precursor solution to easily get into the irregularities in the negative electrode active material particle surfaces when preparing the negative electrode mixture slurry. Moreover, the binder precursor solution can easily get into the irregularities in the negative electrode current collector surface when applying the negative electrode mixture slurry onto the negative electrode current collector. As a result, the anchoring effect between the negative electrode active material particles and between the negative electrode active material particles and the negative electrode current collector is exhibited significantly. Thus, the adhesion between the negative electrode mixture layer and the negative electrode current collector can be made stronger.

The alcohol used for forming the esterified product of a tetracarboxylic dianhydride with an alcohol is not particularly limited. For example, a compound having one alcoholic hydroxy group may be used suitably. Specific examples include aliphatic alcohols, such as methanol, ethanol, isopropanol, and butanol.

In the method of manufacturing a lithium secondary battery according to the present invention, it is preferable that the binder precursor solution contain a diamine. This enables the formation of a polyimide resin having both the branch structure derived from a polyvalent amine and the linear chain structure derived from a diamine and having high mechanical strength and high flexibility.

In the present invention, it is preferable that the value (AX+2Z)/2Y be within the range of from 0.95 to 1.05, where A is the number of the amine groups in the polyvalent amine having a valency of 3 or more, X is the total moles of the polyvalent amine having a valency of 3 or more, Y is the total moles of the tetracarboxylic dianhydride, and Z is the total moles of the diamine. When the value (AX+2Z)/2Y is 1, the ratio of the total number of the amine groups in the binder solution and the total number of the acid dianhydride is the stoichiometric ratio of the imidization reaction. Accordingly, by setting the value (AX+2Z)/2Y to near 1, to be within the range of from 0.95 to 1.05, the imidization reaction and the polymerization reaction proceed desirably, and it becomes possible to obtain a polyimide resin having a long polymer chain and high mechanical strength. On the other hand, if the value (AX+2Z)/2Y is greater than 1.05 or less than 0.95, the total number of acid dianhydride may be too large or too small with respect to the total number of the amine groups. Consequently, a long polymer chain may not be formed. As a consequence, the mechanical strength of the polyimide may be lowered, and good charge-discharge cycle performance may not be obtained.

The foregoing relationship also applies to the cases in which diamine is not used. In such cases, it is preferable that the value AX/2Y be within the range of from 0.95 to 1.05, for the same reason as described above.

It is preferable that the temperature at the time of the heat treatment for causing the polymerization reaction and the subsequent imidization reaction be within the range lower than the temperature at which the weight of the polyimide resin having a branch structure starts to decrease by 5%. Alternatively, when the polyimide resin having a branch structure has a glass transition temperature, it is preferable that the temperature at the time of the heat treatment be a temperature higher than the glass transition temperature. By performing the heat treatment at a temperature higher than the glass transition temperature, the polyimide resin produced is brought into a thermoplastic region. This allows the polyimide resin to get into the irregular portions existing in the surfaces of the negative electrode active material particles and the negative electrode current collector more extensively. As a result, the anchoring effect is exhibited more significantly. That is, the thermal bonding effect of the polyimide resin is exhibited more noticeably. Thus, the adhesion between the negative electrode mixture layer and the negative electrode current collector can be made stronger.

The present invention makes available a lithium secondary battery using at least one of at least one of silicon and a silicon alloy as a negative electrode active material and having high charge-discharge cycle performance.

### BRIEF DESCRIPTION OF THE DRAWINGS

FIG. 1 is a schematic perspective view of an electrode assembly;

FIG. 2 is a schematic plan view illustrating a lithium secondary battery prepared in Example 1; and

FIG. 3 is a schematic cross-sectional view taken along line in FIG. 2.

### DETAILED DESCRIPTION OF THE INVENTION

Hereinbelow, the present invention will be described in detail based on examples thereof. It should be construed, however, that the present invention is not limited to the following preferred embodiments and various changes and modifications are possible without departing from the scope of the invention.

### Example 1

### Preparation of Negative Electrode

### <Preparation of Electrode Active Material>

First, polycrystalline silicon microparticles were introduced in a fluidized bed having an internal temperature of 800° C., and monosilane (SiH₄) was fed therein, to prepare particulate polycrystalline silicon. Next, this particulate polycrystalline silicon was pulverized using a jet mill, and thereafter classified by a classifier, to prepare polycrystalline silicon powder (i.e., a negative electrode active material). The median particle diameter of the polycrystalline silicon powder was 10 μm and the crystallite size of the polycrystalline silicon powder was 44 nm.

The median particle diameter was a particle diameter at 50% cumulative volume in a particle size distribution measurement by a laser diffraction analysis.

The crystallite size was calculated from the half-width of silicon (111) peak measured by a powder X-ray diffraction analysis, using Scherrer's formula.

### <Preparation of Negative Electrode Binder Precursor>

First, 3,3′,4,4′-benzophenonetetracarboxylic dianhydride represented by the following formula (4) is reacted with 2 equivalent weights of ethanol, whereby 3,3′,4,4′-benzophenonetetracarboxylic acid diethyl esters represented by the following formulae (10) and (11) was prepared.

Next, the 3,3′,4,4′-benzophenonetetracarboxylic acid diethyl ester represented by the following formula (10), the 3,3′,4,4′-benzophenonetetracarboxylic acid diethyl ester represented by the following formula (11), tris(4-aminophenyl)methanol represented by the following formula (1), and m-phenylenediamine represented by the following formula (8) were dissolved in NMP (N-methyl-2-pyrrolidone) so that the mole ratio (the 3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) became 105:10:90, to thus obtain a binder precursor solutional.

In the present example, (3X+2Z)/2Y=1, where, in the binder precursor solutional, the total number of moles of the 3,3′,4,4′-benzophenonetetracarboxylic acid diethyl esters [including the one with the structure represented by the formula (10) and the one with the structure represented by the formula (11)] is Y, the number of moles of the tris(4-aminophenyl)methanol represented by the following formula (1) is X, and the number of moles of the m-phenylenediamine represented by the following formula (8).

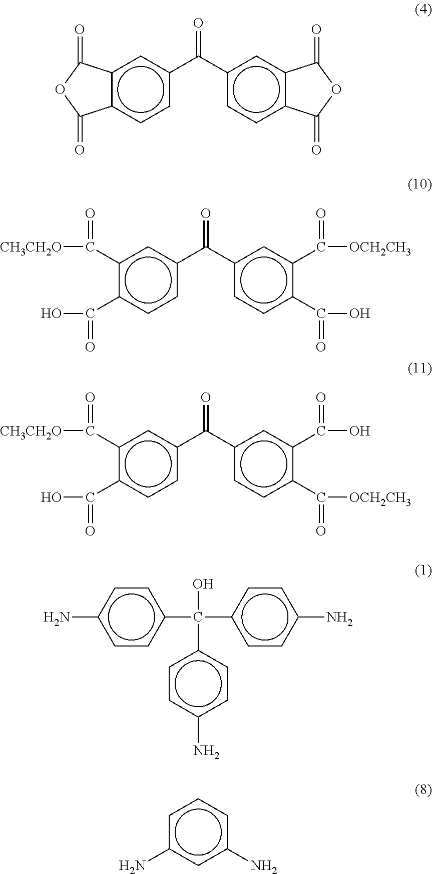

### <Preparation of Negative Electrode Mixture Slurry>

The prepared negative electrode active material, graphite powder having an average particle size of 3 μm as the negative electrode conductive agent, and the prepared negative electrode the binder precursor solutional were mixed together so that the weight ratio of the negative electrode active material powder, the negative electrode conductive agent powder, and the negative electrode binder (the one subjected to the NMP removal by drying the negative electrode binder precursor solutional, the polymerization reaction, and the imidization reaction) became 97:3:8.6, to prepare negative electrode mixture slurry.

### <Preparation of Negative Electrode>

Both sides of a 18 μm-thick copper alloy foil (C7025 alloy foil, containing 96.2 wt % of Cu, 3 wt % of Ni, 0.65 wt % of Si, and 0.15 wt % of Mg) were roughened by an electrolytic copper roughening process so as to have a surface roughness Ra (defined by Japanese Industrial Standard (JIS) B 0601-1994) of 0.25 μm and a mean spacing of local peaks S (also defined by JIS B 0601-1994) of 0.85 μm, to thus prepare a negative electrode current collector.

The negative electrode mixture slurry prepared in the foregoing manner was applied onto both sides of the negative electrode current collector in an air atmosphere at 25° C., then dried in an air atmosphere at 120° C., and thereafter rolled in an air atmosphere at 25° C. After the rolling, the resultant material was cut out into a rectangular shape with a length of 380 mm and a width of 52 mm, and thereafter heat-treated in an argon atmosphere at 400° C. for 10 hours, to thereby prepare a negative electrode in which a negative electrode mixture layer was formed on each side of the negative electrode current collector.

The amount of the negative electrode mixture layer on the negative electrode current collector was 5.6 mg/cm², and the thickness of the negative electrode mixture layer was 56 μm.

Lastly, a nickel plate serving as a negative electrode current collector tab was connected to an end portion of the negative electrode.

In order to confirm the fact that a polyimide compound was produced from the binder precursor solutional by the heat treatment, the following experiment was conducted. First, the binder precursor solutional was dried in an air atmosphere at 120° C. to remove NMP and thereafter heat-treated in an argon atmosphere at 400° C. for 10 hours in the same manner as in the foregoing heat treatment. The infrared (IR) absorption spectrum of the resulting binder precursor solution was analyzed. As a result, a peak originating from an imide bond was observed in the vicinity of 1720 cm⁻¹. Thus, it was confirmed that the polymerization reaction and the imidization reaction proceed by the heat treatment of the binder precursor solutional, whereby a polyimide compound was produced.

### Preparation of Positive Electrode

### <Preparation of Lithium-transition Metal Composite Oxide>

Li₂CO₃ and CoCO₃ were mixed in a mortar so that the mole ratio of Li and Co became 1:1. Thereafter, the mixture was heat-treated in an air atmosphere at 800° C. for 24 hours and then pulverized to obtain powder of a lithium-cobalt composite oxide as the positive electrode active material represented as LiCoO₂ and having an average particle size of 11 μm. In the present example, this lithium-cobalt composite oxide powder was used as a positive electrode active material powder.

The resultant positive electrode active material powder had a BET specific surface area of 0.37 m²/g.

### <Preparation of Positive Electrode>

The above-described positive electrode active material powder, carbon material powder as the positive electrode conductive agent, and polyvinylidene fluoride as the positive electrode binder were added to N-methyl-2-pyrrolidone as a dispersion medium so that the weight ratio of the positive electrode active material powder, the positive electrode conductive agent, and the positive electrode binder became 95:2.5:2.5, and thereafter, the mixture was kneaded to prepare a positive electrode mixture slurry.

The resultant positive electrode mixture slurry was coated onto both sides of an aluminum foil having a thickness of 15 μm, a length of 402 mm, and a width of 50 mm serving as a positive electrode current collector, then dried, and thereafter rolled. The length and the width of the coated portion on the observe side were 340 mm and 50 mm, respectively. The length and the width of the coated portion on the reverse side were 270 mm and 50 mm, respectively. The amount of the mixture layer on the current collector was 48 mg/cm², in a portion in which the positive electrode mixture layers were formed on both sides. The thickness of the positive electrode was 143 μm at a portion in which the positive electrode mixture layer is formed on both sides.

Lastly, an aluminum plate serving as a positive electrode current collector tab was connected to an uncoated portion of the positive electrode mixture layer.

### Preparation of Non-Aqueous Electrolyte Solution

In an argon atmosphere, lithium hexafluorophosphate (LiPF₆) was dissolved at a concentration of 1 mole/L in a mixed solvent of 2:8 volume ratio of fluoroethylene carbonate (FEC) and methyl ethyl carbonate MEC). Thereafter, 0.4 wt % of carbon dioxide gas was added to the resultant solution, to thus prepare a non-aqueous electrolyte solution.

### Preparation of Electrode Assembly

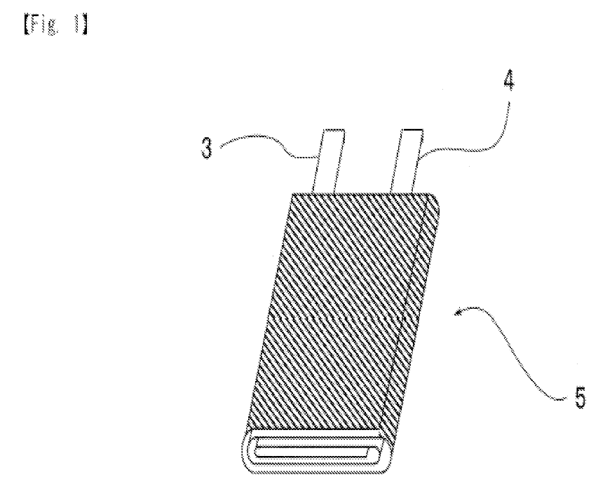

One sheet of the above-described positive electrode, one sheet of the negative electrode, and two sheets of the separator made of a microporous polyethylene film were prepared. The separator made of a microporous polyethylene film had a thickness of 20 μm, a length of 450 mm, and a width of 54.5 mm, and also had a penetration resistance of 340 g and a porosity of 39%. Then, the positive electrode and the negative electrode were disposed facing each other with the separators interposed therebetween, and they were spirally wound around an 18 mm-diameter columnar winding core so that the positive electrode tab and the negative electrode tab were both at the outermost layers. Thereafter, the winding core was drawn out, to prepare a spirally wound electrode assembly. Subsequently, the resultant electrode assembly was compressed to obtain an electrode assembly shown in FIG. 1.

As illustrated in FIG. 1, the resultant electrode assembly was a flat-shape type, and it had a positive electrode current collector tab 3 and a negative electrode current collector tab 4.

### Preparation of Battery

The flat-type electrode assembly prepared in the above-described manner and the above-described electrolyte solution prepared in the above-described manner were put into an aluminum laminate battery case in a CO₂ atmosphere at 25° C. and 1 atm, to prepare a flat-type Battery A1.

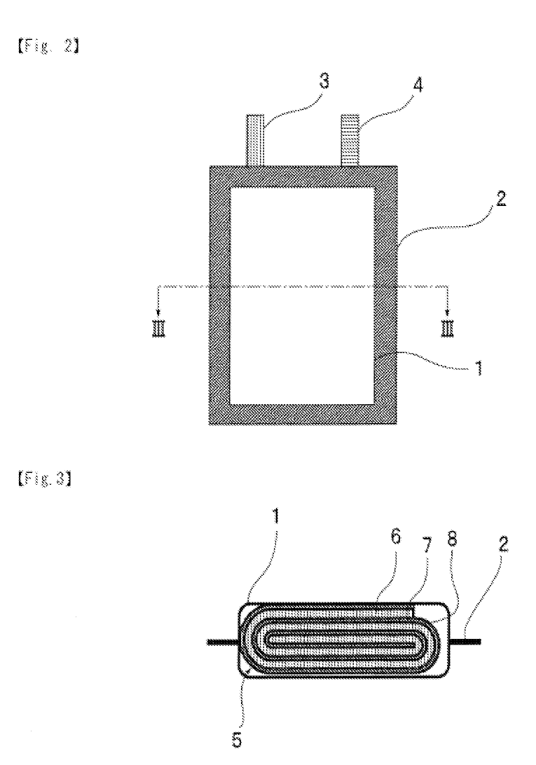

FIG. 2 shows a schematic plan view of Battery A1. FIG. 3 shows a schematic cross-sectional view of Battery A 1.

As illustrated in FIGS. 2 and 3, Battery A1 is provided with a flat-type electrode assembly 5 having a positive electrode 6, a negative electrode 7, a separator 8, a positive electrode current collector tab 3, and a negative electrode current collector tab 4. The flat-type electrode assembly 5 is accommodated in an aluminum laminate battery case 1 having a sealed part 2 that was heat-sealed.

### Example 2

Battery A2 was fabricated in the same manner as described in Example 1 above, except that, in preparing the negative electrode binder precursor solution, 3,4,4′-triaminodiphenyl ether represented by the following formula (2) was used in place of the tris(4-aminophenyl)methanol represented by the above formula (1).

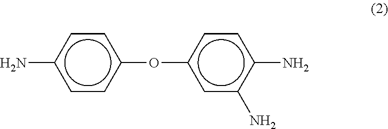

### Example 3

Battery A3 was fabricated in the same manner as described in Example 1 above, except that, in preparing the negative electrode binder precursor solution, 1,2,4-triaminobenzene represented by the following formula (3) was used in place of the tris(4-aminophenyl)methanol represented by the above formula (1).

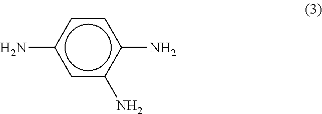

### Example 4

Battery A4 was fabricated in the same manner as described in Example 1 above, except that, in preparing the negative electrode binder precursor solution, 3,4,4′-triaminodiphenyl ether represented by the above formula (2) was added in addition to the tris(4-aminophenyl)methanol represented by the above formula (1) so that the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(3,4,4′-triaminodiphenyl ether):(m-phenylenediamine) became 105:5:5:90.

### Example 5

Battery A5 was fabricated in the same manner as described in Example 1 above, except that, in preparing the negative electrode binder precursor solution, 1,2,4-triaminobenzene represented by the above formula (3) was added in addition to the tris(4-aminophenyl)methanol represented by the above formula (1) so that the mole ratio (3,3′,4,4′-benzophenonetetracarboxylic acid diethyl ester [including the one with the structure represented by the formula (10) and the one with the structure represented by the formula (11)]): (tris(4-aminophenyl)methanol):(1,2,4-triaminobenzene):(m-phenylenediamine) became 105:5:5:90.

### Example 6

Battery A6 was fabricated in the same manner as described in Example 1 above, except that, in preparing the negative electrode binder precursor solution, m-phenylenediamine represented by the above formula (8) was not used, and that the mole ratio (3,3′,4,4′-benzophenonetetracarboxylic acid diethyl ester [including the one with the structure represented by the formula (10) and the one with the structure represented by the formula (11)]): (tris(4-aminophenyl)methanol) was set at 150:100.

### Example 7

Battery A7 was fabricated in the same manner as described in Example 6 above, except that, in preparing the negative electrode binder precursor solution, 3,4,4′-triaminodiphenyl ether represented by the above formula (2) was used in place of the tris(4-aminophenyl)methanol represented by the above formula (1).

### Example 8

Battery A8 was fabricated in the same manner as described in Example 6 above, except that, in preparing the negative electrode binder precursor solution, 1,2,4-triaminobenzene represented by the above formula (3) was used in place of the tris(4-aminophenyl)methanol represented by the above formula (1).

### Example 9

Battery A9 was fabricated in the same manner as described in Example 1 above, except that, in preparing the negative electrode binder precursor solution, 3,3′,4,4′-biphenyltetracarboxylic dianhydride represented by the following formula (12) was used in place of the 3,3′,4,4′-benzophenonetetracarboxylic dianhydride represented by the above formula (4).

In the present example, since 3,3′,4,4′-biphenyltetracarboxylic dianhydride represented by the following formula (12) was used, 3,3′,4,4′-biphenyltetracarboxylic acid diethyl esters represented by the following formulae (13) and (14) were produced in place of the 3,3′,4,4′-benzophenonetetracarboxylic acid diethyl esters represented by the above formulae (10) and (11).

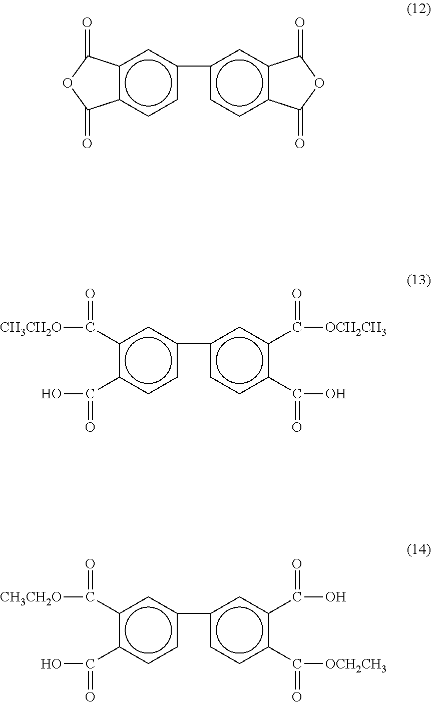

### Example 10

Battery A10 was fabricated in the same manner as described in Example 1 above, except that, in preparing the negative electrode binder precursor solution, 4,4′-methylenedianiline represented by the following formula (15) was used in place of the m-phenylenediamine represented by the above formula (8).

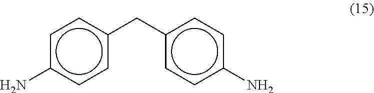

### Example 11

Battery A11 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 101:2:98.

### Example 12

Battery A12 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 102.5:5:95.

### Example 13

Battery A13 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 112.5:25:75.

### Example 14

Battery A14 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 115:30:70.

### Example 15

Battery A15 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 125:50:50.

### Example 16

Battery A16 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 116.7:10:90.

### Example 17

Battery A17 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 110.5:10:90.

### Example 18

Battery A18 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 100:10:90.

### Example 19

Battery A19 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 95.5:10:90.

### Example 20

Battery A20 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 125:25:75.

### Example 21

Battery A21 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 118.4:25:75.

### Example 22

Battery A22 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 107.1:25:75.

### Example 23

Battery A23 was fabricated in the same manner as described in Example 1 above, except that, in preparing the negative electrode binder precursor solution, the mole ratio (3,3′,4,4′-benzophenonetetracarboxylic acid diethyl esters [including the one with the structure represented by the formula (10) and the one with the structure represented by the formula (11)]): (tris(4-aminophenyl)methanol):(m-phenylenediamine) was set at 102.3: 25:75.

### Comparative Example 1

Battery B1 was fabricated in the same manner as described in Example 1 above, except that, in preparing the negative electrode binder precursor solution, the tris(4-aminophenyl)methanol represented by the above formula (1) was not used, and that the mole ratio (3,3′,4,4′-benzophenonetetracarboxylic acid diethyl esters [including the one with the structure represented by the formula (10) and the one with the structure represented by the formula (11)]): (m-phenylenediamine) was set at 100:100.

### Comparative Example 2

Battery B2 was fabricated in the same manner as described in Comparative Example 1 above, except that, in preparing the negative electrode binder precursor solution, 3,3′,4,4′-biphenyltetracarboxylic dianhydride represented by the above formula (12) was used in place of the 3,3′,4,4′-benzophenonetetracarboxylic dianhydride represented by the above formula (4).

### Comparative Example 3

Battery B3 was fabricated in the same manner as described in Comparative Example 1 above, except that, in preparing the negative electrode binder precursor solution, the 4,4′-methylenedianiline represented by the above formula (15) was used in place of the m-phenylenediamine represented by the above formula (8).

### Evaluation of Charge-discharge Cycle Performance

The charge-discharge cycle performance for each of Batteries A1 to A23 and Batteries B1 to B3 was evaluated under the following charge-discharge cycle conditions.

### Charge-Discharge Cycle Conditions

Charge Conditions for the First Cycle

Each of the batteries was charged at a constant current of 50 mA for 4 hours, thereafter charged at a constant current of 200 mA until the battery voltage reached 4.2 V, and further charged at a constant voltage of 4.2 V until the current value reached 50 mA.

Discharge Conditions for the First Cycle

Each of the batteries was discharged at a constant current of 200 mA until the battery voltage reached 2.75 V.

Charge Conditions for the Second Cycle Onward

Each of the batteries was charged at a constant current of 1000 mA until the battery voltage reached 4.2 V and thereafter charged at a constant voltage of 4.2 V until the current value reached 50 mA.

Discharge Conditions for the Second Cycle Onward

Each of the batteries was discharged at a constant current of 1000 mA until the battery voltage reached 2.75 V.

Next, the initial charge-discharge efficiency and the cycle life were determined according to the following. The results are shown in Tables 1 and 2 below.
Initial charge-discharge efficiency=Discharge capacity at the first cycle/Charge capacity at the first cycle×100
Cycle life: The number of cycles at which the capacity retention ratio reached 85%

The capacity retention ratio is a value obtained by dividing the discharge capacity at the n-th cycle by the discharge capacity at the first cycle.

TABLE 1

| | Negative electrode binder | | | | | | | Charge-discharge | |
|---|---|---|---|---|---|---|---|---|---|
| | Tetracarboxylic | | | | | | Ratio of | cycle performance | |
| | dianhydride | | Triamine | | Diamine | | amine/acid | Initial | |
| | | Mole | | Mole | | Mole | anhydride | charge-discharge | Cycle |
| Battery | Structure | ratio | Structure | ratio | Structure | ratio | (AX + 2Z)/2Y | efficiency | life |
| A1 | Formula (4) | 105 | Formula (1) | 10 | Formula (8) | 90 | 1 | 87 | 125 |
| A2 | Formula (4) | 105 | Formula (2) | 10 | Formula (8) | 90 | 1 | 86 | 48 |
| A3 | Formula (4) | 105 | Formula (3) | 10 | Formula (8) | 90 | 1 | 86 | 51 |
| A4 | Formula (4) | 105 | Formula (1) | 5 | Formula (8) | 90 | 1 | 87 | 83 |
| | | | Formula (2) | 5 | | | | | |
| A5 | Formula (4) | 105 | Formula (1) | 5 | Formula (8) | 90 | 1 | 87 | 90 |
| | | | Formula (3) | 5 | | | | | |
| A6 | Formula (4) | 150 | Formula (1) | 100 | — | 0 | 1 | 88 | 73 |
| A7 | Formula (4) | 150 | Formula (2) | 100 | — | 0 | 1 | 86 | 34 |
| A8 | Formula (4) | 150 | Formula (3) | 100 | — | 0 | 1 | 85 | 37 |
| A9 | Formula (12) | 105 | Formula (1) | 10 | Formula (8) | 90 | 1 | 87 | 110 |
| A10 | Formula (4) | 105 | Formula (1) | 10 | Formula (15) | 90 | 1 | 85 | 98 |
| A11 | Formula (4) | 101 | Formula (1) | 2 | Formula (8) | 98 | 1 | 87 | 43 |
| A12 | Formula (4) | 102.5 | Formula (1) | 5 | Formula (8) | 95 | 1 | 87 | 72 |
| A13 | Formula (4) | 112.5 | Formula (1) | 25 | Formula (8) | 75 | 1 | 87 | 128 |
| A14 | Formula (4) | 115 | Formula (1) | 30 | Formula (8) | 70 | 1 | 88 | 108 |
| A15 | Formula (4) | 125 | Formula (1) | 50 | Formula (8) | 50 | 1 | 88 | 89 |

TABLE 2

| | Negative electrode binder | | | | | | | Charge-discharge | |
|---|---|---|---|---|---|---|---|---|---|
| | Tetracarboxylic | | | | | | Ratio of | cycle performance | |
| | dianhydride | | Triamine | | Diamine | | amine/acid | Initial | |
| | | Mole | | Mole | | Mole | anhydride | charge-discharge | Cycle |
| Battery | Structure | ratio | Structure | ratio | Structure | ratio | (AX + 2Z)/2Y | efficiency | life |
| A16 | Formula (4) | 116.7 | Formula (1) | 10 | Formula (8) | 90 | 0.9 | 86 | 112 |
| A17 | Formula (4) | 110.5 | Formula (1) | 10 | Formula (8) | 90 | 0.95 | 87 | 121 |
| A18 | Formula (4) | 100 | Formula (1) | 10 | Formula (8) | 90 | 1.05 | 87 | 122 |
| A19 | Formula (4) | 95.5 | Formula (1) | 10 | Formula (8) | 90 | 1.1 | 86 | 110 |
| A20 | Formula (4) | 125 | Formula (1) | 25 | Formula (8) | 75 | 0.9 | 87 | 115 |
| A21 | Formula (4) | 118.4 | Formula (1) | 25 | Formula (8) | 75 | 0.95 | 87 | 126 |
| A22 | Formula (4) | 107.1 | Formula (1) | 25 | Formula (8) | 75 | 1.05 | 87 | 123 |
| A23 | Formula (4) | 102.3 | Formula (1) | 25 | Formula (8) | 75 | 1.1 | 86 | 116 |
| B1 | Formula (4) | 100 | — | 0 | Formula (8) | 100 | 1 | 87 | 22 |
| B2 | Formula (12) | 100 | — | 0 | Formula (8) | 100 | 1 | 85 | 23 |
| B3 | Formula (4) | 100 | — | 0 | Formula (15) | 100 | 1 | 83 | 20 |

As shown in Tables 1 and 2 above, a comparison of Batteries A1 to A8 and A11 to A23 with Battery B1, a comparison of Battery A9 with Battery B2, and a comparison of Battery A10 with Battery B3 were made. The results demonstrate that Batteries A1 through A23, which use a polyimide resin having a branch structure formed by imidizing a polyvalent amine having a valency of 3 or more and a tetracarboxylic dianhydride as the negative electrode binder, exhibited better charge-discharge cycle life than Batteries B1 through B3, which use a polyimide resin that does not contain a branch structure as the negative electrode binder. Therefore, it is understood that excellent charge-discharge cycle performance can be achieved by using the polyimide resin having a branch structure formed by imidizing a polyvalent amine having a valency of 3 or more and a tetracarboxylic dianhydride as the negative electrode binder contained in the negative electrode mixture layer, which contains negative electrode active material microparticles containing silicon and/or a silicon alloy.

In addition, Batteries A1 to A3, which use, as the negative electrode binder, a polyimide resin containing a linear chain structure formed by an imidization reaction between a diamine and a tetracarboxylic dianhydride in addition to the branch structure, exhibited even better charge-discharge cycle performance than Batteries A6 to A8, which use a polyimide resin not containing the linear chain structure as the negative electrode binder. Therefore, it is understood that even higher charge-discharge cycle performance can be achieved by using the polyimide resin containing a linear chain structure formed by an imidization reaction between a diamine and a tetracarboxylic dianhydride in addition to the branch structure.

From a comparison between Batteries A1 to A10, it is understood that when the types of the tetracarboxylic dianhydride and amine used are changed and the type of the polyimide resin as the negative electrode binder changes, the charge-discharge cycle performance accordingly changes. In addition, Battery A1 exhibited the highest charge-discharge cycle performance among Batteries A1 to A10. Therefore, it is understood that it is more preferable to use, as the negative electrode binder, the polyimide resin produced from the 3,3′,4,4′-benzophenonetetracarboxylic dianhydride represented by the above formula (4), the tris(4-aminophenyl)methanol represented by the above formula (1), and the m-phenylenediamine represented by the above formula (8).

From a comparison between Batteries A1 and A11 through A23, it will be understood that the ratio between the polyvalent amine having a valency of 3 or more that forms a branch structure and the diamine that forms a linear chain structure affects the cycle life. That is, among Batteries A1 and A11 through A23, Batteries A13, A14, and A16 through A23, in which the mole ratio of the polyvalent amine having a valency of 3 or more to diamine is from 10:90 to 30:70, exhibited especially good cycle life. Therefore, it is demonstrated that good cycle life can be achieved by setting the mole ratio of the polyvalent amine having a valency of 3 or more to the diamine to be within the range of from 10:90 to 30:70. It is also understood that a more preferable range of the mole ratio of the polyvalent amine having a valency of 3 or more to the diamine is from 10:90 to 25:75.

From the comparison between Batteries A1 and A16 through A19 as well as from the comparison between Batteries A20 through A23, it is understood that further longer cycle life can be achieved by setting the value (AX+2Z)/2Y, where A is the number of amine groups in the polyvalent amine having a valency of 3 or more, X is the total moles of the polyvalent amine having a valency of 3 or more, Y is the total moles of the tetracarboxylic dianhydride, and Z is the total moles of the diamine, to be within the range of from 0.9 to 1.1. It is also understood that a more preferable range of the value (AX+2Z)/2Y is from 0.95 to 1.05.

The present invention is useful for driving power sources for mobile information terminals such as mobile telephones, notebook computers, and PDAs, especially for power sources that require a high energy density. It is expected that the invention is also applicable to high power applications, such as HEVs and power tools.

While detailed embodiments have been used to illustrate the present invention, to those skilled in the art, however, it will be apparent from the foregoing disclosure that various changes and modifications can be made therein without departing from the spirit and scope of the invention. Furthermore, the foregoing description of the embodiments according to the present invention is provided for illustration only, and is not intended to limit the invention.

What is claimed is:

1. A lithium secondary battery comprising:
an electrode assembly containing a negative electrode, a positive electrode, and a separator interposed between the negative electrode and the positive electrode; and a non-aqueous electrolyte impregnated in the electrode assembly,
the negative electrode having a negative electrode current collector and a negative electrode mixture layer formed on the negative electrode current collector, the negative electrode mixture layer containing a binder and negative electrode active material particles containing at least one of silicon and a silicon alloy, and
the binder containing a polyimide resin having a branch structure formed by imidizing a polyvalent amine having a valency of 3 or more and a tetracarboxylic dianhydride.

2. A lithium secondary battery according to claim 1, wherein:
the polyvalent amine having a valency of 3 or more includes at least one of triamines represented by the following formulae (1) to (3): 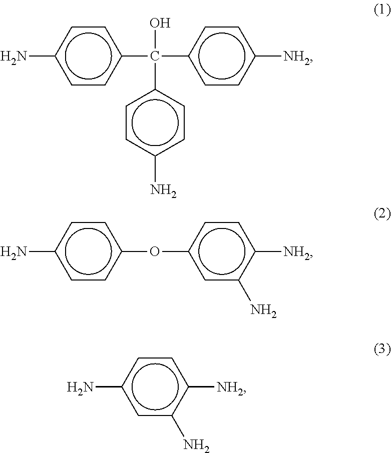
the tetracarboxylic dianhydride is a tetracarboxylic dianhydride represented by the following formula (4): 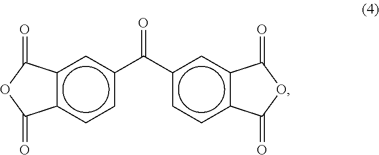
and
the branch structure includes at least one of branch structures represented by the following formulae (5) to (7):

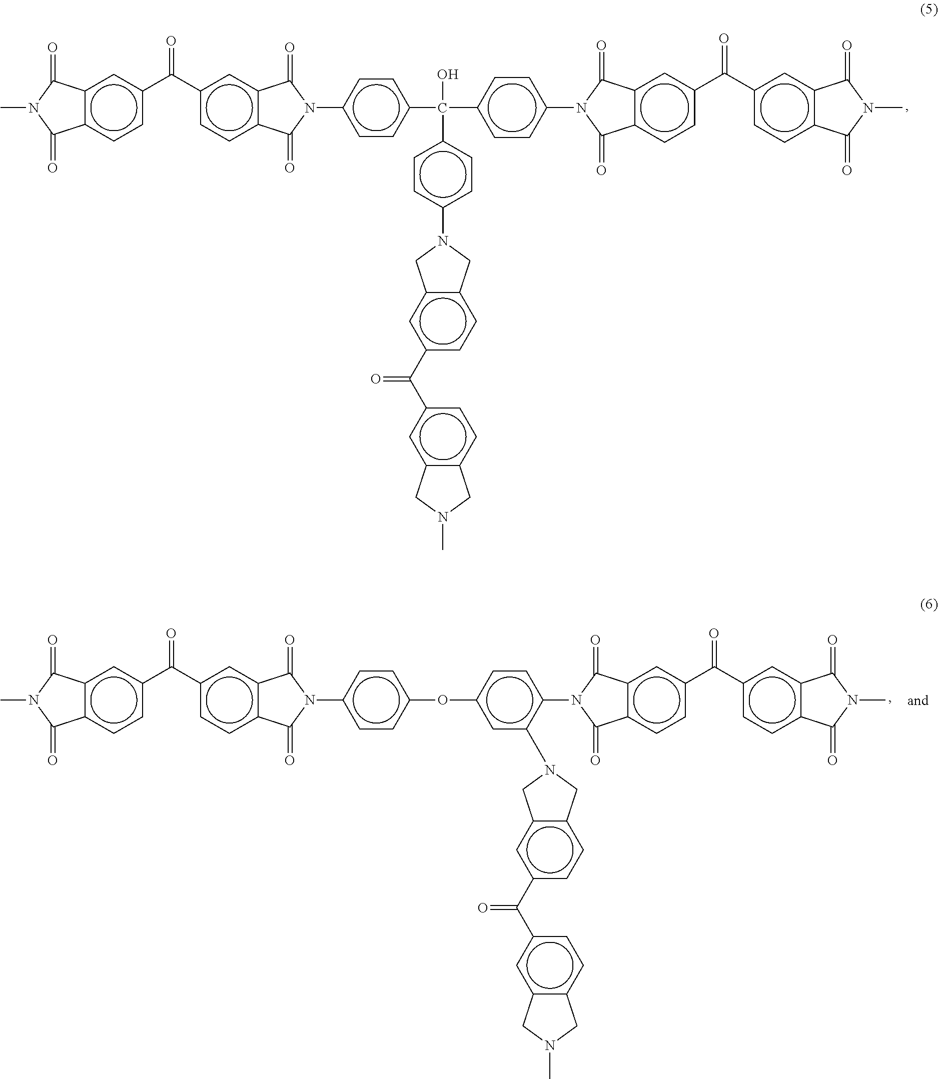

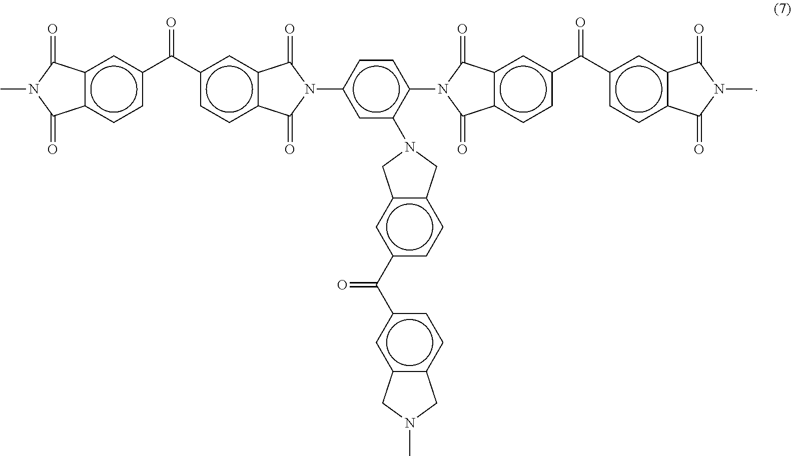

3. The lithium secondary battery according to claim 1, wherein the polyimide resin further comprises a linear chain structure formed by imidizing a diamine and a tetracarboxylic dianhydride.

4. The lithium secondary battery according to claim 3, wherein the linear chain structure is a linear chain structure represented by the following formula (9): 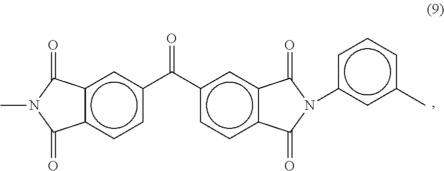
the linear chain structure being formed by imidizing the tetracarboxylic dianhydride represented by the above formula (4) and the following formula (8):

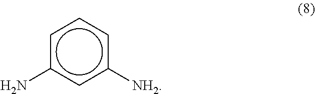

5. The lithium secondary battery according to claim 3, wherein the mole ratio of the branch structure derived from a polyvalent amine having a valency of 3 or more and the linear chain structure derived from a diamine [(the branch structure derived from a polyvalent amine having a valency of 3 or more):(the linear chain structure derived from a diamine)] is within the range of from 10:90 to 30:70.

6. A method of manufacturing a lithium secondary battery according to claim 1, the method comprising the steps of:
adding a polyvalent amine having a valency of 3 or more to an esterified product of a tetracarboxylic dianhydride with an alcohol formed by reacting the tetracarboxylic dianhydride with a monohydric alcohol to prepare a binder precursor solution;
dispersing the negative electrode active material particles in the binder precursor solution to prepare a negative electrode mixture slurry;
applying the negative electrode mixture slurry onto the negative electrode current collector;
heat-treating the negative electrode current collector on which the negative electrode mixture slurry is applied in a non-oxidizing atmosphere so as to cause an imidization reaction and a polymerization reaction of the tetracarboxylic dianhydride and the polyvalent amine having a valency of 3 or more, whereby the polyimide resin having a branch structure is formed, to prepare the negative electrode;
interposing a separator between the negative electrode and the positive electrode to prepare the electrode assembly; and
impregnating the electrode assembly with the non-aqueous electrolyte to prepare the lithium secondary battery.
